(19) United States
(12) Patent Application Publication
(10) Pub. No.: US 2025/0206968 A1
(43) Pub. Date: Jun. 26, 2025

(54) VOC-FREE URETHANE COPOLYMER

(71) Applicant: COATEX, Genay (FR)

(72) Inventors: Guillaume MICHAUD, Lyon (FR); Jean-marc SUAU, Lucenay (FR)

(73) Assignee: COATEX, Genay (FR)

(21) Appl. No.: 18/847,855

(22) PCT Filed: Mar. 28, 2023
(86) PCT No.: PCT/FR2023/000032

§ 371 Date: Sep. 17, 2024

(30) Foreign Application Priority Data
Apr. 1, 2022 (FR) FR2202994

(51) Int. Cl. C09D 7/65; C08G 18/28; C08G 18/48; C08G 18/75; C09D 7/45

(52) U.S. Cl. CPC C09D 7/65; C08G 18/2825; C08G 18/2835; C08G 18/4833; C08G 18/755; C08G 18/758; C09D 7/45

(57) ABSTRACT

A process for preparing a urethane copolymer may use a polyalkoxylated and polyhydroxylated compound which does not contain any volatile residue of alkanes, aromatic hydrocarbon compounds, or alkenes. Such a copolymer can be useful as an agent for controlling rheology in an aqueous medium, in particular for paint compositions, for paper coating slips or for cosmetic compositions.

The invention relates to a method for preparing a urethane copolymer using a polyalkoxylated and polyhydroxylated compound that does not comprise any volatile alkane residue, any volatile aromatic hydrocarbon compound residue or any volatile alkene residue. The copolymer according to the invention is useful as a rheology control agent in an aqueous medium, particularly for paint compositions, for paper coating colours or for cosmetic compositions.

In general, for aqueous coating compositions, and in particular for aqueous paint or varnish compositions, it is necessary to control the viscosity both for low or medium shear gradients and for high shear gradients. Indeed, during its preparation, storage, application or drying, a paint formulation is subjected to numerous stresses requiring particularly complex rheological properties. The paint formulation must have a high viscosity at high shear gradients. Reduced viscosity at low or medium shear gradients will also help to achieve a neat, taut appearance after the paint has been applied. Moreover, to ensure there are no drips, the paint formulation needs to have a high viscosity at low and medium shear gradients. To ensure that the paint has a high levelling capacity after it has been deposited on a surface, the paint formulation must have a low viscosity at low and medium shear gradients.

Moreover, when preparing paper coating colours, it is also necessary to improve viscosity at low shear gradients, while improving water retention within the aqueous composition used. These compositions must have viscosities at different shear gradients that allow them to be used effectively, particularly when applied to the surface finish of a sheet of paper. These compositions must have an apparent viscosity, thus at a low shear gradient, which is well suited to effective application.

Furthermore, when preparing aqueous cosmetic compositions, rheology control is an essential property. In fact, the viscosity of these cosmetic compositions must not only be controlled during their preparation, transport or storage, but also when applying them. The use of these aqueous cosmetic compositions, particularly on the skin or hair, requires properties that are often very specific from a rheological and safety point of view.

The compatibility of the various constituents of an aqueous composition with controlled rheology is also an important property, as is the presence in small amounts, or even the absence, of certain harmful or prohibited compounds within these compositions. In particular, these aqueous compositions or the compounds used when preparing them should not comprise volatile organic compounds, particularly alkanes, aromatic hydrocarbon compounds or alkenes. These compounds should not be present in ingredients used in the preparation of paint or varnish compositions or used in the preparation of paper coating colours. In particular, rheology control agents as well as the compounds used in their preparation should contain only negligible or zero amounts of alkane residue, aromatic hydrocarbon compound residue or alkene residue. In particular, the presence of such compounds must absolutely be controlled in order to prevent their release when using paint or varnish compositions or when making paper or packaging, and in particular when making paper or packaging for food products.

Controlling the potential presence of such compounds is therefore essential to ensure the final quality of the aqueous compositions used. This control should therefore be both effective and straightforward, using techniques that are widely available.

Document EP0889100 discloses a thickening associative polyurethane compound. Document WO 2007048766A2 describes compositions comprising an associative polyurethane thickener and ethoxylated mono- or diglycerides of carboxylic acids. WO 2019091819 describes a composition comprising a polyurethane prepared using a particular Guerbet alcohol in combination with a particular surfactant compound. Document WO2018073545 describes a rheological control agent comprising a polyurethane prepared in the absence of diisocyanate compound.

There is therefore a need for a method for preparing rheology control agents that can provide a solution to all or part of the problems encountered when preparing known copolymers.

The invention therefore provides a method for preparing a copolymer P comprising the polymerisation reaction:
a) of at least one isocyanate compound (a) independently chosen among a diisocyanate compound (a1), a polyisocyanate compound (a2) and combinations thereof;
b) of at least one compound (b) of formula I:

R—(X)ₘ—OH (I)
wherein:
   R independently represents a group chosen among a straight C₄-C₄₀-alkyl group, a branched C₄-C₄₀-alkyl group, a C₅-C₄₀-cycloalkyl group, a C₅-C₄₀-aryl group and combinations thereof,
   m represents 0 or a number ranging from 1 to 200,
   X independently represents an alkoxylated group chosen among oxyethylene, oxypropylene, oxybutylene and combinations thereof;
c) of at least one polyhydroxylated polyalkoxylated compound (c) comprising an amount of at least one compound chosen among alkanes, aromatic hydrocarbon compounds, alkenes and combinations thereof, measured by GC-MS, that is less than 0.5 ppm by weight of compound (c).

The method according to the invention comprises the use of the compound (a) during the polymerisation reaction. Preferably, the polymerisation reaction uses a single compound (a) or two or three different compounds (a). More preferably, the polymerisation reaction uses a single compound (a).

Preferably according to the invention, the compound (a) is a diisocyanate compound (a1) chosen among:
the symmetric aromatic diisocyanate compounds, preferably:
2,2′-methylene diphenyl diisocyanate (2,2′-MDI) and 4,4′-methylene diphenyl diisocyanate (4,4′-MDI);
4,4′-dibenzyl diisocyanate (4,4′-DBDI);
2,6-toluene diisocyanate (2,6-TDI);
m-xylylene diisocyanate (m-XDI);
the symmetric alicyclic diisocyanate compounds, preferably methylene bis(4-cyclohexylisocyanate) (H12MDI);
the symmetric aliphatic diisocyanate compounds, preferably hexamethylene diisocyanate (HDI), pentamethylene diisocyanate (PDI);
the asymmetric aromatic diisocyanate compounds, preferably:
2,4′-methylene diphenyl diisocyanate (2,4′-MDI);
2,4′-dibenzyl diisocyanate (2,4′-DBDI);
2,4-toluene diisocyanate (2,4-TDI);
the asymmetric alicyclic diisocyanate compounds, preferably isophorone diisocyanate (IPDI).

More preferably according to the invention, the compound (a1) is chosen among IPDI, HDI, H12MDI and combinations thereof.

Also preferably according to the invention, the compound (a) is a polyisocyanate compound (a2) strictly comprising more than 2 isocyanate groups or more than 2.2 isocyanate groups or even more than 2.5 isocyanate groups. More preferably, the polyisocyanate compound (a2) comprises more than 2.6 isocyanate groups or more than 2.7 isocyanate groups or more than 3 isocyanate groups; more preferably, the polyisocyanate compound (a2) comprises from 2.2 to 6 isocyanate groups, from 2.2 to 4 isocyanate groups, from 2.2 to 3.5 isocyanate groups, from 2.5 to 6 isocyanate groups, from 2.2 to 5 isocyanate groups, from 2.5 to 4 isocyanate groups, from 2.5 to 3.5 isocyanate groups, in particular from 2.6 to 3.3 isocyanate groups.

Also preferably according to the invention, the compound (a) is a polyisocyanate (a2) chosen among:
triphenylmethane-4,4′,4″-triisocyanate or 1,1′,1″-methylidynetris (4-isocyanatobenzene); or
an isocyanurate compound, in particular an isocyanurate compound of a compound chosen among:
the symmetric aromatic diisocyanate compounds, preferably:
2,2′-methylene diphenyl diisocyanate (2,2′-MDI) and 4,4′-methylene diphenyl diisocyanate (4,4′-MDI);
4,4′-dibenzyl diisocyanate (4,4′-DBDI);
2,6-toluene diisocyanate (2,6-TDI);
m-xylylene diisocyanate (m-XDI);
the symmetric alicyclic diisocyanate compounds, preferably bis(4-cyclohexylisocyanate) methylene (H12MDI);
the symmetric aliphatic diisocyanate compounds, preferably hexamethylene diisocyanate (HDI), pentamethylene diisocyanate (PDI);
the asymmetric aromatic diisocyanate compounds, preferably:
2,4′-methylene diphenyl diisocyanate (2,4′-MDI);
2,4′-dibenzyl diisocyanate (2,4′-DBDI);
2,4-toluene diisocyanate (2,4-TDI);
a biuret trimer compound, in particular a biuret trimer compound of a compound chosen among:
the symmetric aromatic diisocyanate compounds, preferably:
2,2′-methylene diphenyl diisocyanate (2,2′-MDI) and 4,4′-methylene diphenyl diisocyanate (4,4′-MDI);
4,4′-dibenzyl diisocyanate (4,4′-DBDI);
2,6-toluene diisocyanate (2,6-TDI);
m-xylylene diisocyanate (m-XDI);
the symmetric alicyclic diisocyanate compounds, preferably methylene bis(4-cyclohexylisocyanate) (H12MDI);
the symmetric aliphatic diisocyanate compounds, preferably hexamethylene diisocyanate (HDI), pentamethylene diisocyanate (PDI);
the asymmetric aromatic diisocyanate compounds, preferably:
2,4′-methylene diphenyl diisocyanate (2,4′-MDI);
2,4′-dibenzyl diisocyanate (2,4′-DBDI);
2,4-toluene diisocyanate (2,4-TDI);
the asymmetric alicyclic diisocyanate compounds, preferably isophorone diisocyanate (IPDI).

More preferably, the compound (a2) is chosen among triphenylmethane-4,4′,4″-triisocyanate, 1,1′,1″-methylidynetris (4-isocyanatobenzene), an HDI isocyanurate, an IPDI isocyanurate, a PDI isocyanurate, an HDI biuret trimer and an IPDI biuret trimer, a PDI biuret trimer.

Preferably according to the invention, the compound (b) is a compound of formula I wherein R independently represents a group chosen among a straight C₄-C₄₀-alkyl group, a branched C₄-C₄₀-alkyl group, a C₅-C₄₀-cycloalkyl group, a C₅-C₄₀-aryl group, and combinations thereof.

Preferably according to the invention, the compound (b) is a compound of formula I wherein R independently represents a straight C₄-C₃₆-alkyl group, a branched C₄-C₃₆-alkyl group or a C₅-C₃₆-aryl group; preferably a straight C₆-C₃₆-alkyl group, a branched C₆-C₃₆-alkyl group or a C₆-C₃₆-aryl group; more preferentially a straight C₆-C₂₄-alkyl group, a branched C₆-C₂₄-alkyl group or a C₆-C₂₄-aryl group.

Also preferably according to the invention, the compound (b) is a compound of formula I wherein X independently represents an ethoxylated group or a combination of ethoxylated groups and propoxylated groups, more preferentially X represents an ethoxylated group.

Also preferably according to the invention, the compound (b) is a compound of formula I wherein m represents 0 or a number ranging from 1 to 150, preferably from 1 to 100 or from 1 to 50, more preferentially from 2 to 50 or from 2 to 25.

More preferably according to the invention, the compound (b) is a compound of formula I wherein:
R independently represents a straight C₄-C₃₆-alkyl group, a branched C₄-C₃₆-alkyl group or a C₅-C₃₆-aryl group; preferably a straight C₆-C₃₆-alkyl group, a branched C₆-C₃₆-alkyl group or a C₆-C₃₆-aryl group; more preferentially a straight C₆-C₂₄-alkyl group, a branched C₆-C₂₄-alkyl group or a C₆-C₂₄-aryl group;
X independently represents an ethoxylated group or a combination of ethoxylated groups and propoxylated groups, more preferentially X represents an ethoxylated group; and
m represents 0 or a number ranging from 1 to 150, preferably from 1 to 100 or from 1 to 50, more preferentially from 2 to 50 or from 2 to 25.

Preferably according to the invention, the compound (c) is a compound (c1) of formula II:

HO-Lₙ-OH (II)
wherein:
L independently represents an oxyalkylene residue;
n independently represents a number ranging from 30 to 1,000.

Preferably according to the invention, the compound (c) is a compound (c1) of formula II wherein L independently represents an oxyethylene residue or wherein n independently represents a number ranging from 50 to 400, preferably from 100 to 300. More preferably according to the invention, the compound (c) is a compound (c1) of formula II wherein L independently represents an oxyethylene residue and n independently represents a number ranging from 50 to 400, preferably from 100 to 300. The compound (c1) can be used alone or it can be combined with one or more other compounds. In this case, the compound (c1) of formula II can be combined with a non-alkoxylated compound (c2) comprising at least three hydroxyl groups. Preferably according to the invention, the compound (c2) comprises three hydroxyl groups, more preferably, the compound (c2) is chosen among glycerol, pentaerythritol and combinations thereof.

According to the invention, the compound (c) can also be combined with a polyalkoxylated compound (c3) comprising at least three hydroxyl groups. According to the invention, the polyalkoxylated compound (c3) is different from the compound (c2). Preferably according to the invention, the polyalkoxylated compound (c3) is polyethoxylated pentaerythritol or comprises three hydroxyl groups, more preferably the compound (c3) is polyethoxylated glycerol.

The method according to the invention can use one or more combinations of the compounds (c1), (c2) and (c3).

Essentially according to the invention, the polyhydroxylated compound (c) is polyalkoxylated. It therefore comprises alkoxylated groups. Preferably, the method according to the invention uses a compound (c) comprising from 10 to 150 alkoxylations, more preferentially from 20 to 100 alkoxylations or from 10 to 70 alkoxylations. More preferentially, the compound (c) comprises from 20 to 60 alkoxylations.

Also preferably, the method according to the invention uses a compound (c) that is polyethoxylated or that is polyethoxylated-polypropoxylated or that is polyethoxylated-polybutoxylated. More preferably, the compound (c) is polyethoxylated. Particularly preferably, the compound (c) comprises from 10 to 150 ethoxylations, more preferentially from 20 to 100 ethoxylations or from 10 to 70 ethoxylations. Much more preferentially, the compound (c) comprises from 20 to 60 ethoxylations.

The preparation method according to the invention can use polyalkoxylated compounds (c), (c1) and (c3) whose molar mass (Mw) measured by SEC can vary in substantial proportions. Preferably according to the invention, the compounds (c), (c1) or (c3) independently have a molar mass (Mw) measured by SEC ranging from 1,500 to 40,000 g/mol, preferably from 2,000 to 20,000 g/mol. More preferentially according to the invention, the molar mass (Mw) of the compounds (c), (c1) or (c3) independently ranges from 2,000 to 15,000 g/mol or from 2,000 to 12,000 g/mol.

According to the invention, the molar mass of the compounds (c), (c1) or (c3) is determined by Size Exclusion Chromatography (SEC), a.k.a. “Gel Permeation Chromatography” (GPC). This technique uses a “Waters” liquid chromatography instrument equipped with a detector. This detector is a “Waters” 2414 refractive index detector. This liquid chromatography instrument is equipped with two size exclusion columns in order to separate the various molecular weights of the polymers or compounds studied. The liquid elution phase is an organic phase comprised of THF (HPLC grade, not stabilised).

In a first step, about 25 mg of compound is dissolved in 5 mL of THF, to which is added 0.1 mol % of water used as internal flow marker. Then, the solution is filtered through a 0.2 μm filter. 50 μL are then injected into the chromatography instrument (eluent: THF, HPLC grade, not stabilised).

The liquid chromatography instrument has an isocratic pump (“Waters” 515), the flow rate of which is set to 0.3 mL/min. The chromatography instrument also comprises an oven that comprises a system of columns in series: an “Agilent” PLgel MiniMIX-A column 250 mm long and 4.6 mm in diameter followed by an “Agilent” PLgel MiniMIX-B column 250 mm long and 4.6 mm in diameter. The detection system is comprised of a “Waters” 2414 RI refractive index detector. The columns are kept at a temperature of 35° C. and the refractometer is brought to a temperature of 35° C.

The chromatography instrument is calibrated using polymethyl methacrylate standards certified by the “Agilent” supplier (“EasiVial” PMMA).

According to the invention, the compound (c) can be used in various liquid or solid forms, preferably solid at a temperature above 25° C. In solid form, the compound (c) can take various forms, for example in a form chosen among pellets, flakes, pulp, chips, powder and combinations thereof.

Essentially according to the invention, the compound (c) has a very high degree of purity, particularly with regard to the presence of volatile organic compounds, especially residual volatile organic compounds from the methods used for its preparation. Thus, the compound (c) used according to the invention comprises a zero or particularly low amount of alkanes, aromatic hydrocarbon compounds or alkenes.

According to the invention, the amounts of residual compounds are measured using widely available and easy-to-use techniques. In fact, and particularly advantageously according to the invention, the amounts of residual compounds are measured by gas chromatography coupled with mass spectrometry (GC-MS). The chromatograph used is equipped with a mass spectrometer as a detector. According to the invention, measurement by GC-MS comprises injecting the compound (c) to be analysed into the chromatograph at a controlled temperature, then separating the various volatile compounds using a capillary column, then detecting any residual volatile compounds using a mass spectrometer and analytically processing the detection peaks.

Thus, the compound (c) used according to the invention comprises an amount of at least one compound chosen among alkanes, aromatic hydrocarbon compounds, alkenes and combinations thereof, measured by GC-MS, that is less than 0.5 ppm by weight of compound (c).

Preferably according to the invention, the compound (c) comprises an amount of alkanes that is less than 0.5 ppm by weight of compound (c). Also preferably according to the invention, the compound (c) comprises an amount of aromatic hydrocarbon compounds that is less than 0.5 ppm by weight of compound (c). Also preferably according to the invention, the compound (c) comprises an amount of alkenes that is less than 0.5 ppm by weight of compound (c).

More preferably according to the invention, the compound (c) comprises an amount of alkanes that is less than 0.2 ppm by weight, preferably an amount that is less than 0.1 ppm by weight or even zero, measured by GC-MS.

Preferentially, the alkanes according to the invention are chosen among C₃-C₂₀-alkanes, particularly C₇-C₁₄-alkanes.

Also more preferably according to the invention, the compound (c) comprises an amount of aromatic hydrocarbon compounds that is less than 0.2 ppm by weight, preferably an amount that is less than 0.1 ppm by weight or even zero, measured by GC-MS.

Also preferentially, the aromatic hydrocarbon compounds according to the invention are chosen among toluene, benzene, xylene, naphthalene and combinations thereof.

Also more preferably according to the invention, the compound (c) comprises an amount of alkenes that is less than 0.2 ppm by weight, preferably an amount that is less than 0.1 ppm by weight or even zero, measured by GC-MS.

Also preferentially, the alkenes according to the invention are chosen among C₇-C₁₄-alkenes and combinations thereof.

Particularly preferably according to the invention, the compound (c) therefore does not comprise any alkane or does not comprise any aromatic hydrocarbon compound or does not comprise any alkene. More preferably according to the invention, the compound (c) comprises neither alkane, nor aromatic hydrocarbon compound, nor alkene.

According to the invention, a zero amount of a compound, in particular a compound chosen among alkanes, aromatic hydrocarbon compounds or alkenes, characterises not only the total absence of this compound but also its presence in an amount that is non-significant from an analytical point of view. The limits of quantification generally accepted using analytical techniques for this compound therefore characterise its absence within the compound (c) used according to the invention.

When preparing the copolymer P according to the invention, the amounts of compounds (a), (b) and (c) can vary. Preferably, the method according to the invention comprises a polymerisation reaction that uses from 20 to 74.9 mol %, preferably from 25 to 60 mol %, of compound (a) relative to the total molar amount of compounds (a), (b) and (c).

Also preferably, the method according to the invention comprises a polymerisation reaction that uses from 25 to 79.9 mol %, preferably from 35 to 70 mol %, of compound (b) relative to the total molar amount of compounds (a), (b) and (c). Also preferably, the method according to the invention comprises a polymerisation reaction that uses from 0.1 to 55 mol %, preferably from 5 to 40 mol %, of compound (c) relative to the total molar amount of compounds (a), (b) and (c).

Preferably, the method according to the invention comprises a polymerisation reaction that uses:
from 20 to 74.9 mol % or from 25 to 60 mol % of compound (a) or
from 25 to 79.9 mol % or from 35 to 70 mol % of compound (b), or
from 0.1 to 55 mol % or from 5 to 40 mol % of compound (c), relative to the total molar amount of compounds (a), (b) and (c).

More preferably, the method according to the invention comprises a polymerisation reaction that uses:
from 20 to 74.9 mol %, preferably from 25 to 60 mol %, of compound (a),
from 25 to 79.9 mol %, preferably from 35 to 70 mol %, of compound (b), and
from 0.1 to 55 mol %, preferably from 5 to 40 mol %, of compound (c), relative to the total molar amount of compounds (a), (b) and (c).

In addition to the compounds (a), (b) and (c), the preparation method according to the invention also comprises the option to use other compounds during the polymerisation reaction.

Thus, the preparation method according to the invention can also comprise a polymerisation reaction that also uses at least one hydrophobic compound (d) of formula III:

R¹—(OE)_{q}-(OP)ₜ—OH (III)
wherein:
q and r, identical or different, independently represent 0 or an integer or decimal less than 150, q is different from 0,
EO independently represents a CH₂CH₂O group,
PO independently represents a group chosen among CH(CH₃)CH₂O and CH₂CH(CH₃)O,
R¹ independently represents a group chosen among a straight C₄-C₄₀-alkyl group, a branched C₄-C₄₀-alkyl group, a C₅-C₄₀-cycloalkyl group, a C₅-C₄₀-aryl group, and combinations thereof.

The invention also relates to a method for preparing a copolymer Pc comprising the polymerisation reaction of at least one compound (a), of at least one compound (b) and of at least one compound (d).

Preferably according to the invention, the compound (d) is a compound of formula III wherein:
r represents 0; or
R¹ represents a straight or branched C₆-C₄₀-alkyl group, a phenyl group, a polyphenyl group, preferably a straight or branched C₁₀-C₃₀-alkyl group, more preferentially a straight or branched C₁₂-C₂₂-alkyl group, or a group comprising 2 to 5 phenyls or a tristyrylphenyl group or a pentastyrylcumylphenyl group.

Also preferably according to the invention, the polymerisation reaction uses less than 20 mol %, preferably from 0.05 to 20 mol %, particularly from 0.1 to 10 mol %, of compound (d) relative to the total molar amount of monomers.

The preparation method according to the invention makes it possible to obtain copolymer P. When preparing this copolymer, the compound (c) used comprises a small or zero amount of alkanes, of aromatic hydrocarbon compounds or of alkenes. Prior to the polymerisation reaction, the invention makes it possible to select the compound (c) based on the amount of alkanes, of aromatic hydrocarbon compounds or of alkenes that it may optionally comprise. Thus, the invention provides a method for preparing a copolymer P according to the invention that also comprises the selection prior to the polymerisation reaction of the polyhydroxylated compound (c) comprising measurement by GC-MS of the amount Q of at least one compound chosen among alkanes, aromatic hydrocarbon compounds, alkenes and combinations thereof, then:
the use of the compound (c) if the amount Q is zero or
the elimination of the compound (c) if the amount Q is not zero or if it is greater than 0.5 ppm by weight of compound (c).

GC-MS measurement can be used to determine the amount of at least one compound chosen among alkanes, aromatic hydrocarbon compounds, alkenes and combinations thereof, that can be present in the compound (c). The invention provides a method for selecting a polyhydroxylated compound (c) comprising measurement by GC-MS of the amount Q of at least one compound chosen among alkanes, aromatic hydrocarbon compounds, alkenes and combinations thereof, then:
the use of the compound (c) if the amount Q is zero or
the elimination of the compound (c) if the amount Q is not zero.

The selection method according to the invention comprises an elimination step that can be total or partial, in particular based on the amount present within the compound (c) of any compound chosen among alkanes, aromatic hydrocarbon compounds, alkenes and combinations thereof.

The preparation method according to the invention is particularly effective for obtaining a copolymer P comprising a reduced or zero content of alkanes, of aromatic hydrocarbon compounds or of alkenes. The invention also provides a copolymer P prepared according to the preparation method according to the invention. Preferably, the copolymer P according to the invention comprises an amount of at least one compound chosen among alkanes, aromatic hydrocarbon compounds, alkenes and combinations thereof, measured by GC-MS, that is less than 0.5 ppm by weight of compound (c), more preferentially an amount less than 0.1 ppm by weight of compound (c) or even a zero amount of compound chosen among alkanes, aromatic hydrocarbon compounds, alkenes and combinations thereof.

The copolymer P according to the invention is particularly useful for controlling the rheology of aqueous compositions. The invention provides a method for preparing a rheology modifying agent comprising the preparation of a copolymer P according to the invention and the mixing of the copolymer P with at least one compound chosen among a solvent, in particular water or a coalescent solvent, for example glycol, butyl glycol, butyldiglycol, monopropylene glycol, ethylene glycol, ethylenediglycol, “Dowanol” products with CAS number 34590-94-8, “Texanol” products with CAS number 25265-77-4.

In particular within the rheology modifying agent, the copolymer P can be combined with at least one additive chosen among an amphiphilic compound, in particular a surfactant compound, preferably a hydroxylated surfactant compound, for example alkyl-polyalkylene glycol, particularly alkyl-polyethylene glycol and alkyl-polypropylene glycol; a polysaccharide derivative, for example cyclodextrin, cyclodextrin derivative, polyethers, alkyl glucosides; a hydrotropic compound, an anti-foaming agent, a biocide and combinations thereof.

Preferably according to the invention, the rheology modifying agent comprises a copolymer P according to the invention and at least one substance of natural origin, in particular a substance chosen among a hydroxylated surfactant compound of natural origin, for example alkyl-polyalkylene glycol of natural origin, in particular alkyl-polyethylene glycol of natural origin; a polysaccharide derivative of natural origin, for example cyclodextrin of natural origin, cyclodextrin derivative of natural origin, polyethers, alkyl glucosides of natural origin and combinations thereof.

The invention also relates to an aqueous formulation comprising:
at least one copolymer P or at least one rheology modifying agent according to the invention and, optionally,
at least one organic or mineral pigment or organic, organo-metallic or mineral particles, for example calcium carbonate, talc, kaolin, mica, silicates, silica, metal oxides, in particular titanium dioxide, iron oxides; and optionally
at least one agent chosen among a particle-spacer agent, a dispersing agent, a stabilising steric agent, an electrostatic stabilising agent, an opacifying agent, a colouring agent, a solvent, a coalescent agent, an anti-foaming agent, a preservative agent, a biocide, a spreading agent, a thickening agent, a film-forming copolymer, and mixtures thereof.

Preferably, the aqueous formulation according to the invention is a coating formulation, in particular an ink formulation, a varnish formulation, an adhesive formulation, a paint formulation, for example a decorative paint or an industrial paint formulation.

The invention also provides a concentrated aqueous pigment pulp comprising at least one copolymer P according to the invention and at least one coloured organic or mineral pigment.

Particularly advantageously, the rheology modifying agent according to the invention can be used in aqueous media. The invention thus provides an aqueous composition comprising at least one copolymer P according to the invention and at least one rheology modifying agent according to the invention. Preferably according to the invention, this composition is a coating composition, in particular a paint or varnish composition, or a paper coating composition or a cosmetic composition or a detergent composition or an adhesive composition.

The copolymer P prepared according to the invention has rheology control properties that are particularly effective for aqueous compositions. The invention provides a method for controlling the viscosity of an aqueous composition comprising the addition to this composition of at least one copolymer P according to the invention.

The advantageous, particular or preferred characteristics of the preparation method according to the invention define copolymers P, aqueous compositions, formulations, pigment pulps as well as selection methods and viscosity control methods according to the invention that are also advantageous, particular or preferred.

The following examples illustrate the various aspects of the invention.

### EXAMPLES

### Example 1: Preparation and Characterisation of Copolymers P1 to P6 According to the Invention

The compounds used are chosen among:
diisocyanate compound (a): isophorone diisocyanate (IPDI), compound (ala),
diisocyanate compound (a): 4,4′-diisocyanato dicyclohexylmethane (H12MDI), compound (a1b),
compound (b): compound (ba) of formula I wherein R represents a cardanyl group, ethoxylated 4 times,
compound (b): compound (bb) of formula I wherein R represents a 1-hexanyl group,
compound (b): compound (bc) of formula I wherein R represents a 1-ethylhexanyl group,
compound (b): compound (bd) of formula I wherein R represents a 1-octanyl group,
compound (b): compound (be) of formula I wherein R represents a 1-dodecanyl group,
compound (c): compound (c1a) of formula II wherein L represents an oxyethylene residue and n represents about 225 (“Vita Clariant” polyglycol 10,000 SG).

The compound (c1a) is analysed by GC-MS using a gas chromatograph (“Agilent” 7890B) comprising a headspace injector (“Agilent” 7967A) and a mass spectrometer (“Agilent” 5977B) as a detector.

A 2 g sample of compound is placed in a vial (screw-top, 2 mL headspace) and injected into the chromatograph. After detection and processing of the peaks of the compounds present in the sample, in addition to compound (c1a), the presence of the compounds listed in Table 1 is characterised.

TABLE 1

| Compounds | CAS No. | Peak Area |
|---|---|---|
| acetic acid | 64-19-7 | 3,917,922 |
| 1,3-dioxolane | 646-06-0 | 837,994 |
| methoxyethanol | 109-86-4 | 352,184 |
| 2-methyldioxolane | 497-26-7 | 1,448,755 |
| 1-butanol | 71-36-3 | 576,441 |
| methoxyacetone | 5878-19-3 | 126,220 |
| glycol monoformate | 628-35-3 | 516,091 |
| ethylene formate | 629-15-2 | 616,318 |
| benzene | 71-43-2 | 0 |
| decane | 124-18-5 | 0 |
| dodecane | 112-40-3 | 0 |
| tetradecane | 629-59-4 | 0 |

261.9 g of compound (c1a) and 24.8 g of compound (ba) are introduced into a 2 L reactor. This is heated to 90° C. under vacuum for 30 min, then 12.8 g of compound (ala) is introduced and the heat is increased and kept at a temperature of 100° C. for 45 min. The result is polymer P1 according to the invention.

Polymers P2 to P5 are similarly prepared according to the invention. The compounds and amounts (g) used are shown in Table 2.

TABLE 2

| | Polymers | | | | |
|---|---|---|---|---|---|
| | P1 | P2 | P3 | P4 | P5 |
| compound (a1a) | 12.8 | | 15.0 | 13.7 | 16.7 |
| compound (a1b) | | 8.8 | | | |
| compound (ba) | 24.8 | | | | |
| compound (bb) | | 3.7 | | | |
| compound (bc) | | | 8.8 | | |
| compound (bd) | | | | 8.0 | |
| compound (be) | | | | | 14.0 |
| compound (c1a) | 261.9 | 186.9 | 225.5 | 227.8 | 268.5 |

### Example 2: Preparation and Characterisation of Rheology Modifying Agents RM1 to RM5 According to the Invention

The polymer P1 in example 1 is cooled to 60° C. and then mixed with 266.4 g of a surfactant compound (“Seppic” “Simulsol” SL7G) and 432.9 g of water to obtain the rheology modifying agent RM1 according to the invention.

Similarly, the rheology modifying agent RM2 according to the invention is prepared by mixing polymer P2 with 799.2 g of water.

The rheology modifying agent RM3 according to the invention is prepared by mixing polymer P3 with 749.2 g of water.

The rheology modifying agent RM4 according to the invention is prepared by mixing polymer P4 with 749.4 g of water.

The rheology modifying agent RM5 according to the invention is prepared by mixing polymer P5 with 266.4 g of surfactant compound (“Seppic” “Simulsol” SL7G) and 432.9 g of water.

For each rheology modifying agent, the resulting viscosity at low gradient is determined: Brookfield viscosity at 100 rpm (spindle No. 6), denoted BV (mPa·s). These measurements are done 24 hours after the agent has been prepared. The agents are thermostated to 25±0.5° C. The results are shown in Table 3.

TABLE 3

| Agent | Viscosity BV (mPa · s) |
|---|---|
| RM1 | 8,700 |
| RM2 | 3,200 |
| RM3 | 2,250 |
| RM4 | 4,700 |
| RM5 | 6,400 |

### Example 3: Preparation and Characterisation of Aqueous Coating Compositions CC1 to CC5 According to the Invention

Each composition is prepared by mixing the various ingredients. The ingredients and amounts (in g) are listed in Table 4.

TABLE 4

| Ingredients in the aqueous paint formulation | Amount (g) |
|---|---|
| “Ecodis” P50 (“Coatex” dispersant) | 2.00 |
| “Tego” 810 (“Tego” anti-foaming agent) | 0.51 |
| “Acticide” MBS (“Thor” bactericide) | 1.00 |
| “TiONa” 568 (“Tronox” TiO₂) | 40.01 |
| “Omyacoat” 850 OG (“Omya” CaCO₃) | 110.00 |
| “Durcal” 2 AV (“Omya” CaCO₃) | 150.29 |
| “Acronal” S790 (“BASF” binder) | 65.00 |
| Monopropylene glycol | 5.06 |
| “Texanol” (“Eastman” coalescent agent) | 5.02 |
| NaOH (20% by weight in water) | 0.41 |
| Agent RM1 to RM5 (30% by weight of P1 to P5) | 4.70 |
| Water | 116.00 |
| Total | 500.00 |

For each composition, the resulting viscosities are determined at different shear gradients:
at low gradient: Brookfield viscosities at 10 rpm and 100 rpm, respectively denoted BV10 and BV100 (mPa·s),
at medium gradient: Stormer viscosity (Krebs Unit, KU),
at high gradient: ICI viscosity (mPa·s).

These measurements are done 24 hours after the formulation has been prepared. The formulations are thermostated to 25±0.5° C. The results are shown in Table 5.

TABLE 5

| | Viscosity | | | |
|---|---|---|---|---|
| Compositions | BV10 | BV100 | Stormer | ICI |
| (copolymers) | (mPa · s) | (mPa · s) | (KU) | (mPa · s) |
| CC1 (P1) | 11,800 | 3,700 | 108 | 0.9 |
| CC2 (P2) | 3,200 | 2,000 | 99 | 2.7 |
| CC3 (P3) | 1,400 | 900 | 78 | 2.1 |
| CC4 (P4) | 2,200 | 1,400 | 91 | 2.2 |
| CC5 (P5) | 6,200 | 4,800 | 133 | 1.6 |

The copolymers according to the invention make it possible to effectively thicken a solvent-free matt paint at different shear gradients.

In the field of aqueous paints, high viscosity at low or medium shear gradients reflects good static behaviour. Thus, good stability is ensured during storage while avoiding the settling phenomenon and limiting the tendency to flow on vertical substrates.

These paint compositions do not comprise any VOCs from the polyhydroxylated compound used when preparing the copolymer according to the invention.

1. A method for preparing a copolymer P, the method comprising:
polymerizing a polymerization mixture comprising:
(a) an isocyanate compound (a) comprising a diisocyanate compound (a1) and/or a polyisocyanate compound (a2);
(b) a compound (b) of formula (I):
R—(X)ₘ—OH (I),
R independently being a straight C₄-C₄₀-alkyl group, a branched C₄-C₄₀-alkyl group, a C₅-C₄₀-cycloalkyl group, a C₅-C₄₀-aryl group, or a combination thereof, m being 0 or a number in a range of from from 1 to 200, and X is independently an alkoxylated group chosen among oxyethylene, oxypropylene, oxybutylene, or a combination thereof;
(c) a polyhydroxylated polyalkoxylated compound (c) comprising an alkane, aromatic hydrocarbon compound, and/or alkene, in an amount measured by GC-MS, that is less than 0.5 ppm by weight of polyhydroxylated polyalkoxylated compound (c).

2. The method of claim 1, wherein
the diisocyanate compound (a1) comprises a symmetric aromatic diisocyanate compound, a symmetric alicyclic diisocyanate compound, an asymmetric aromatic diisocyanate compound, and
asymmetric alicyclic diisocyanate compound.

3. The method of claim 1, wherein, in the compound (b),
R is independently a straight C₄-C₃₆-alkyl group, a branched C₄-C₃₆-alkyl group, or a C₅-C₃₆-aryl group, or
X is independently an ethoxylated group or a combination of ethoxylated groups and propoxylated groups, or
m is 0 or a number in a range of from 1 to 150.

4. The method of claim 1, wherein the polyhydroxylated polyalkoxylated compound (c) comprises:
a compound (c1) of formula (II):
HO-Lₙ-OH (II),
L independently being an oxyalkylene residue, and n independently being a number in a range of from 30 to 1,000,
the compound (c1) of formula (II) combined with a non-alkoxylated compound (c2) comprising at least three hydroxyl groups, and/or;
a polyalkoxylated compound (c3) comprising at least three hydroxyl groups.

5. The method of claim 1, wherein the polyhydroxylated polyalkoxylated compound (c) comprises:
a compound (c1) of formula (II):
HO-Lₙ-OH (II),
L independently being an oxyethylene residue and n independently being a number in a range of from 50 to 400;
a compound (c2) comprising three hydroxyl groups; and/or
polyethoxylated pentaerythritol or a polyalkoxylated compound (c3) different from the compound (c2) and comprising three hydroxyl groups.

6. The method of claim 1, wherein the polyhydroxylated polyalkoxylated compound (c) comprises from 10 to 150 alkoxylations.

7. The method of claim 1, wherein the polyhydroxylated polyalkoxylated compound (c) has a molar mass Mw, measured by SEC, in a range of from 1,500 to 40,000 g/mol.

8. The method of claim 1, wherein the polyhydroxylated polyalkoxylated compound (c) comprises
less than 0.2 ppm by weight, measured by GC-MS, of alkanes, or
less than 0.2 ppm by weight, measured by GC-MS, of aromatic hydrocarbon compounds, or
less than 0.2 ppm by weight, measured by GC-MS, of alkenes.

9. The method of claim 1, wherein the polymerization mixture comprises:
the isocyanate compound (a) in a range of from 20 to 74.9 mol. %, or
the compound (b) in a range of from 25 to 79.9 mol %, or
from 0.1 to 55 mol %, preferably from 5 to 40 mol %, of the polyhydroxylated polyalkoxylated compound (c) in a range of from 0.1 to 55 mol. %,
relative to a total molar amount of the compounds (a), (b) and (c).

10. The method of claim 1, wherein the polymerization mixture further comprises a hydrophobic compound (d) different from the compound (b).

11. A method for selecting a polyhydroxylated compound (c), the method comprising:
measuring, by GC-MS, an amount Q of a compound comprising an alkane, aromatic hydrocarbon compound, and/or alkene, then
using a polyhydroxylated polyalkoxylated compound (c) if the amount Q is zero, or
eliminating the polyhydroxylated polyalkoxylated compound (c) if the amount Q is not zero.

12. A copolymer P, prepared by the method of claim 1.

13. A method for preparing a rheology modifying agent, the method comprising:
preparing a copolymer P of claim 1;
mixing the copolymer P with a compound comprising a solvent, or with an additive comprising an amphiphilic compound.

14. A rheology modifying agent, comprising:
the copolymer P of claim 12; and
a substance of natural origin.

15. An aqueous composition, comprising:
the copolymer P of claim 14, or a rheology modifying agent comprising the copolymer P and a substance of natural origin.

16. The composition of claim 15, which is a coating composition.

17. A method for controlling the viscosity of an aqueous composition, the method comprising:
combining the copolymer P of claim 1 and a precursor to the aqueous composition.

18. The method of claim 1, wherein the polyisocyanate compound (a2) comprises more than 2 isocyanate groups.

19. The method of claim 1, wherein the polyisocyanate compound (a2) comprises triphenylmethane-4,4′,4″-triisocyanate, 1,1′,1″-methylidynetris-(4-isocyanatobenzene), 2,2′-methylene diphenyl diisocyanate, 4,4′-methylene diphenyl diisocyanate, 4,4′-dibenzyl diisocyanate, 2,6-toluene diisocyanate, m-xylylene diisocyanate, 2,4′-methylene diphenyl diisocyanate, 2,4′-dibenzyl diisocyanate, 2,4-toluene diisocyanate, a biuret trimer compound, 2,2′-methylene diphenyl diisocyanate, 4,4′-methylene diphenyl diisocyanate, 4,4′-dibenzyl diisocyanate, toluene 2,6-diisocyanate, m-xylylene diisocyanate, 2,4′-methylene diphenyl diisocyanate, 2,4′-dibenzyl diisocyanate, and/or toluene 2,4-diisocyanate.
